(19) United States
(12) Patent Application Publication
(10) Pub. No.: US 2024/0347253 A1
(43) Pub. Date: Oct. 17, 2024

(54) INDUCTOR COMPONENT

(71) Applicant: Murata Manufacturing Co., Ltd., Kyoto-fu (JP)

(72) Inventors: Kazunori ANNEN, Nagaokakyo-shi (JP); Kenichi TANI, Nagaokakyo-shi (JP)

(73) Assignee: Murata Manufacturing Co., Ltd., Kyoto-fu (JP)

(21) Appl. No.: 18/632,985

(22) Filed: Apr. 11, 2024

(30) Foreign Application Priority Data
Apr. 14, 2023 (JP) 2023-066495

(51) Int. Cl. H01F 17/00; H01F 27/29

(52) U.S. Cl. CPC H01F 17/0013; H01F 2017/002; H01F 27/292

(57) ABSTRACT

An inductor component includes a base body, a coil inside the base body and helically wound along the axis, and first and second outer electrodes in the base body and electrically connected to the coil. The base body includes first and second end surfaces opposite each other, first and second side surfaces opposite each other, a bottom surface connected between the first and second end surfaces and between the first and second side surfaces, and a top surface opposite the bottom surface. The first and second outer electrodes are at least on the bottom surface. The axis is parallel to the bottom surface and intersects with the first and second side surfaces. The coil includes coil wiring layers stacked along the axis, and a via wiring layer configured to connect adjacent ones of the coil wiring layers in an axial direction, which is a direction of the axis.

### CROSS-REFERENCE TO RELATED APPLICATION

This application claims benefit of priority to Japanese Patent Application No. 2023-066495, filed Apr. 14, 2023, the entire content of which is incorporated herein by reference.

### BACKGROUND

### Technical Field

The present disclosure relates to an inductor component.

### Background Art

An example of inductor components is disclosed in Japanese Unexamined Patent Application Publication No. 2019-192829. This inductor component includes a base body, a coil disposed inside the base body and helically wound along an axis, and a first outer electrode and a second outer electrode disposed in the base body and electrically connected to the coil. The coil includes a plurality of coil wiring layers stacked along the axis, and a via wiring layer configured to connect adjacent ones of the coil wiring layers in a direction of the axis.

### SUMMARY

In the inductor component of the related art described above, the via wiring layer has a prismatic shape, and the area of contact between the coil wiring layer and the via wiring layer is small. This may increase direct-current resistance of the coil.

Accordingly, the present disclosure provides an inductor component that can reduce direct-current resistance of a coil.

An inductor component according to an aspect of the present disclosure includes a base body, a coil disposed inside the base body and helically wound along an axis, and a first outer electrode and a second outer electrode disposed in the base body and electrically connected to the coil. The base body includes a first end surface and a second end surface opposite each other, a first side surface and a second side surface opposite each other, a bottom surface connected between the first end surface and the second end surface and between the first side surface and the second side surface, and a top surface opposite the bottom surface. The first outer electrode and the second outer electrode are disposed at least on the bottom surface. The axis is parallel to the bottom surface and intersects with the first side surface and the second side surface. The coil includes a plurality of coil wiring layers stacked along the axis, and a via wiring layer configured to connect adjacent ones of the coil wiring layers in an axial direction, which is a direction of the axis. The via wiring layer includes at least one longitudinal via wiring layer having a longitudinal shape and extending along a helical direction of the coil, as viewed in the axial direction, and the at least one longitudinal via wiring layer includes a first longitudinal via wiring layer having a radius of curvature of greater than or equal to 15 μm, as viewed in the axial direction.

Here, the longitudinal via wiring layer refers to a via wiring layer whose center line along the direction in which the via wiring layer extends, as viewed in the axial direction, is longer than the width thereof in the direction orthogonal to the center line along the direction in which the via wiring layer extends. When the first longitudinal via wiring layer has a plurality of radii of curvature, it is simply required that the smallest radius of curvature be greater than or equal to 15 μm.

In the aspect described above, the via wiring layer includes at least one longitudinal via wiring layer having a longitudinal shape and extending along the helical direction of the coil, as viewed in the axial direction. This can increase the area of contact between the coil wiring layer and the longitudinal via wiring layer and reduce direct-current resistance of the coil.

The at least one longitudinal via wiring layer includes a first longitudinal via wiring layer having a radius of curvature of greater than or equal to 15 μm, as viewed in the axial direction. The first longitudinal via wiring layer thus has a large radius of curvature. Therefore, even if the difference between the coefficient of linear expansion of the first longitudinal via wiring layer and the coefficient of linear expansion of the base body causes stress, the stress is unlikely to concentrate on the first longitudinal via wiring layer. In particular, even if miniaturization of the inductor component increases the ratio of the volume of the first longitudinal via wiring layer to the volume of the base body, the stress on the first longitudinal via wiring layer can be relieved. This can reduce the occurrence of cracks in the first longitudinal via wiring layer and improve the yield of the inductor component.

The inductor component according to the aspect of the present disclosure, described above, can reduce direct-current resistance of the coil.

### BRIEF DESCRIPTION OF THE DRAWINGS

FIG. 1 is a perspective view illustrating a first embodiment of an inductor component;

FIG. 2 is a transparent front view of the inductor component, as viewed from a first side surface;

FIG. 3A is an exploded plan view of the inductor component;

FIG. 3B is another exploded plan view of the inductor component;

FIG. 3C is another exploded plan view of the inductor component;

FIG. 4 is a transparent front view of a second embodiment of the inductor component, as viewed from the first side surface of the inductor component;

FIG. 5A is an exploded plan view of the inductor component; and

FIG. 5B is another exploded plan view of the inductor component.

### DETAILED DESCRIPTION

An inductor component, which is an aspect of the present disclosure, will now be described in detail by illustrated embodiments. Note that the accompanying drawings include schematic representations and do not necessarily reflect actual dimensions or ratios.

### First Embodiment

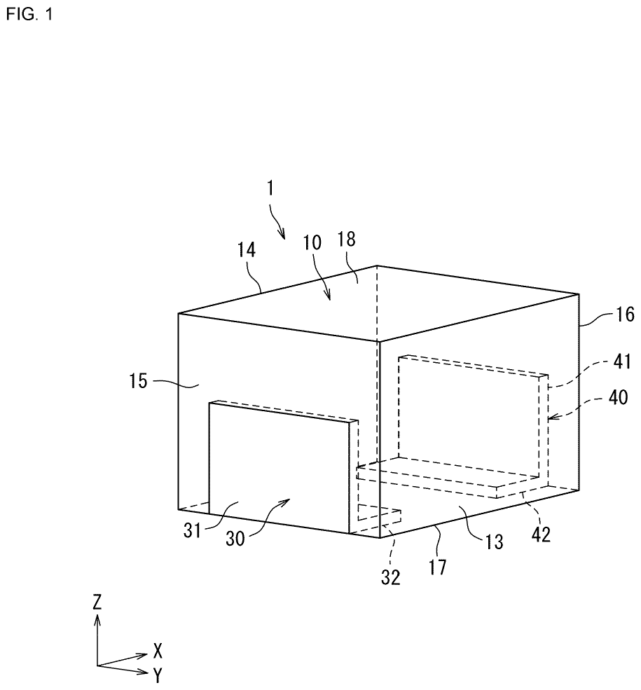

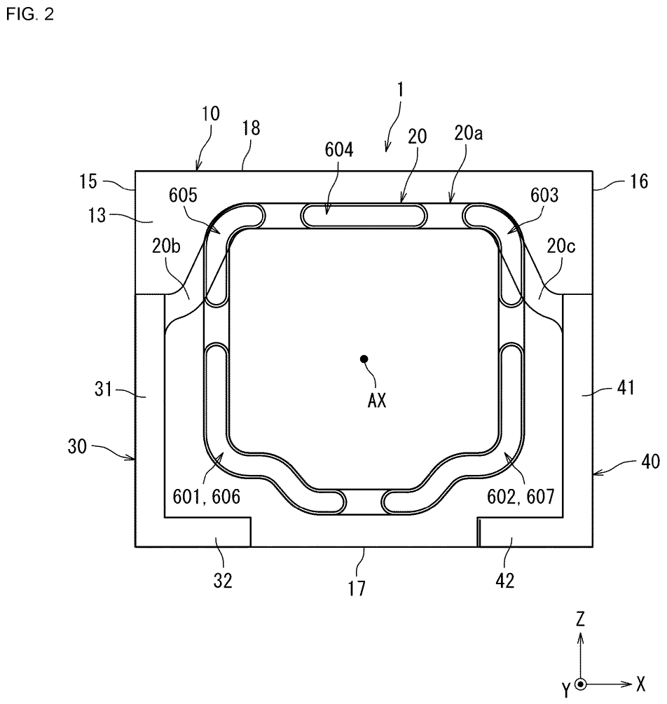

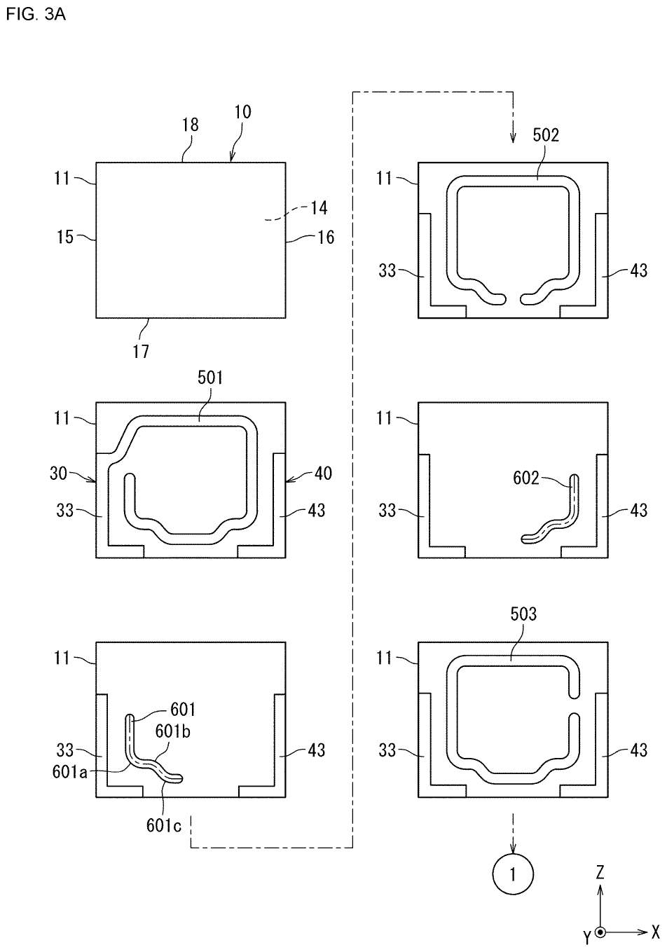

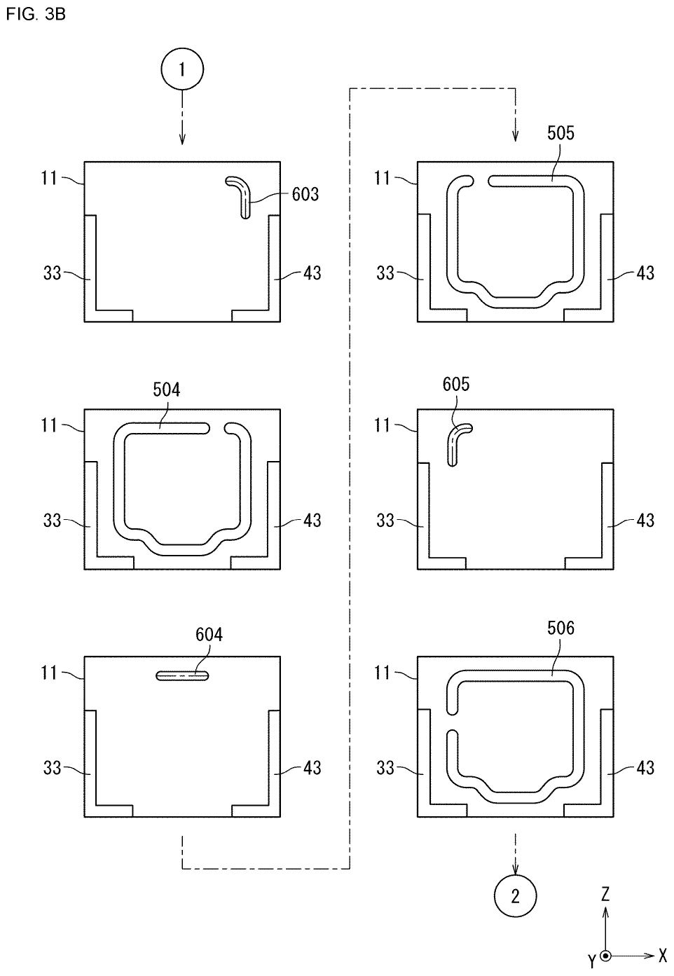

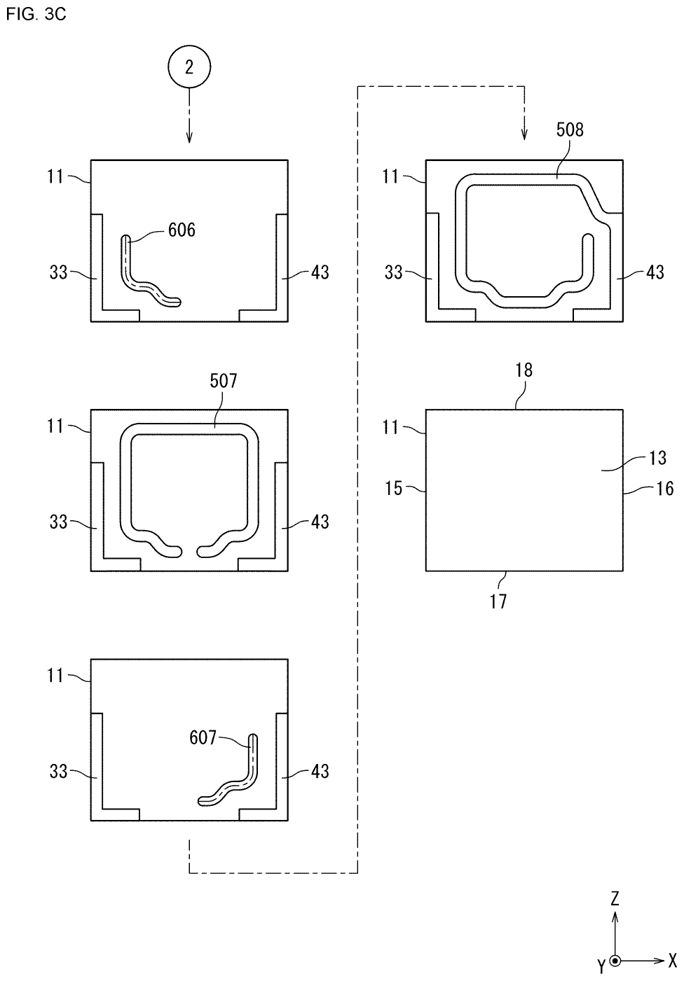

FIG. 1 is a perspective view illustrating a first embodiment of an inductor component. FIG. 2 is a transparent front view of the inductor component, as viewed from a first side surface. FIG. 3A, FIG. 3B, and FIG. 3C are exploded plan views of the inductor component. As illustrated in FIG. 1, FIG. 2, FIG. 3A, FIG. 3B, and FIG. 3C, an inductor component 1 includes a base body 10, a coil 20 disposed inside the base body 10 and helically wound along an axis AX, and a first outer electrode 30 and a second outer electrode 40 disposed in the base body 10 and electrically connected to the coil 20. The base body and the coil are illustrated as being transparent in FIG. 2 for easy understanding of the structure, but they may be either semitransparent or opaque.

The inductor component 1 is electrically connected at the first and second outer electrodes 30 and 40 to wires on a circuit board (not illustrated). The inductor component 1 is used, for example, as an impedance matching coil (matching coil) of a high-frequency circuit and used in electronic devices, such as personal computers, DVD players, digital cameras, TV sets, mobile phones, car electronics, and medical and industrial machines. Applications of the inductor component 1 are not limited to this. For example, the inductor component 1 may also be used in tuning circuits, filter circuits, and rectifier and smoothing circuits.

The base body 10 is substantially in the shape of a rectangular parallelepiped. The surface of the base body 10 includes a first end surface 15 and a second end surface 16 opposite each other, a first side surface 13 and a second side surface 14 opposite each other, a bottom surface 17 connected between the first end surface 15 and the second end surface 16 and between the first side surface 13 and the second side surface 14, and a top surface 18 opposite the bottom surface 17. The bottom surface 17 is a surface facing a mount board (not illustrated) when the inductor component 1 is mounted on the mount board.

As illustrated, an X direction is a direction orthogonal to the first end surface 15 and the second end surface 16, and is directed from the first end surface 15 toward the second end surface 16. A Y direction is a direction orthogonal to the first side surface 13 and the second side surface 14, and is directed from the second side surface 14 toward the first side surface 13. A Z direction is a direction orthogonal to the bottom surface 17 and the top surface 18, and is directed from the bottom surface 17 toward the top surface 18. The X direction is also referred to as the direction of the length of the base body 10, the Y direction is also referred to as the direction of the width of the base body 10, and the Z direction is also referred to as the direction of the height of the base body 10. The X direction, the Y direction, and the Z direction are directions orthogonal to each other and constitute a left-handed system when arranged in the order of X, Y, and Z.

The base body 10 is formed by stacking a plurality of insulating layers 11. The insulating layers 11 are made of, for example, a material mainly composed of borosilicate glass, or a material such as ferrite or resin. The stacking direction of the insulating layers 11 is a direction (Y direction) parallel to the first and second end surfaces 15 and 16 and the bottom surface 17 of the base body 10. That is, the insulating layers 11 are layers extending in the XZ plane. The term “parallel” in the present application is not limited to an exactly parallel relation, but encompasses a substantially parallel relation when the range of variation in practice is taken into consideration. In the base body 10, the interfaces between the insulating layers 11 may be unclear because of, for example, firing. In FIG. 3A, FIG. 3B, and FIG. 3C, the direction from top to bottom is the stacking direction (Y direction).

The first outer electrode 30 and the second outer electrode 40 are made of a conductive material, such as Ag, Cu, Au, or an alloy mainly composed of any of these materials. The first outer electrode 30 is an L-shaped electrode extending from the first end surface 15 to the bottom surface 17. The first outer electrode 30 is embedded in the base body 10 to be exposed at the first end surface 15 and the bottom surface 17. The first outer electrode 30 has a first end surface portion 31 extending along the first end surface 15, and a first bottom surface portion 32 connected to the first end surface portion 31 and extending along the bottom surface 17. The surfaces of the first outer electrode 30 and the second outer electrode 40 exposed in the base body 10 may be, for example, Ni or Sn plated.

The second outer electrode 40 is an L-shaped electrode extending from the second end surface 16 to the bottom surface 17. The second outer electrode 40 is embedded in the base body 10 to be exposed at the second end surface 16 and bottom surface 17. The second outer electrode 40 has a second end surface portion 41 extending along the second end surface 16, and a second bottom surface portion 42 connected to the second end surface portion 41 and extending along the bottom surface 17.

The first outer electrode 30 has a structure formed by stacking a plurality of first outer electrode conductor layers 33 embedded in the base body 10 (insulating layers 11). The second outer electrode 40 has a structure formed by stacking a plurality of second outer electrode conductor layers 43 embedded in the base body 10 (insulating layers 11). The first outer electrode conductor layers 33 extend along the first end surface 15 and the bottom surface 17, and the second outer electrode conductor layers 43 extend along the second end surface 16 and the bottom surface 17.

The first and second outer electrodes 30 and 40 can thus be embedded in the base body 10. This can make the inductor component smaller than with a structure where outer electrodes are external to the base body 10. Also, since the coil 20 and the outer electrodes 30 and 40 can be produced in the same process, variation in positional relation between the coil 20 and the outer electrodes 30 and 40 can be reduced. This can reduce variation in the electrical characteristics of the inductor component 1.

The first outer electrode 30 may be constituted by the first bottom surface portion 32 without the first end surface portion 31. Similarly, the second outer electrode 40 may be constituted by the second bottom surface portion 42 without the second end surface portion 41. That is, the first outer electrode 30 and the second outer electrode 40 are simply required to be disposed at least on the bottom surface 17 of the base body 10.

For example, the coil 20 is made of a conductive material similar to, or the same as, that used to make the first and second outer electrodes 30 and 40. The coil 20 is helically wound along the stacking direction of the insulating layers 11. The coil 20 is connected at a first end thereof to the first outer electrode 30, and connected at a second end thereof to the second outer electrode 40. In the present embodiment, the coil 20 and the first and second outer electrodes 30 and 40 are integrated and there are no clear boundaries between them. However, the configuration is not limited to this. The coil and the outer electrodes may be made of different materials or produced by different techniques; that is, there may be boundaries between them.

The coil 20 is wound along the axis AX such that the axis AX is parallel to the bottom surface 17 and that the axis AX intersects with the first side surface 13 and the second side surface 14. The axis AX of the coil 20 coincides with the stacking direction of the insulating layers 11 (Y direction). In other words, the insulating layers 11 are stacked along the axis AX. The axis AX of the coil 20 refers to the central axis of the helical shape of the coil 20. Specifically, the axis AX refers to the center of the innermost circumference of the coil 20.

The coil 20 has a wound portion 20a, a first extended portion 20b connected between a first end of the wound portion 20a and the first outer electrode 30, and a second extended portion 20c connected between a second end of the wound portion 20a and the second outer electrode 40. In the present embodiment, the wound portion 20a and the first and second extended portions 20b and 20c are integrated and there are no clear boundaries between them. However, the configuration is not limited to this. The wound portion and the extended portions may be made of different materials or produced by different techniques; that is, there may be boundaries between them.

The wound portion 20a is helically wound along the axis AX. That is, the wound portion 20a refers to a helically wound portion where different parts of the coil 20 coincide, as viewed in a direction parallel to the axis AX. The first and second extended portions 20b and 20c refer to portions outside the coinciding parts.

As viewed in the direction of the axis AX of the coil 20, the coil 20 is bilaterally symmetrical with respect to a straight line passing through the axis AX of the coil 20 and parallel to the Z direction. This can reduce variation in characteristics of the inductor component 1.

As illustrated in FIG. 3A, FIG. 3B, and FIG. 3C, the coil 20 includes a plurality of coil wiring layers 501 to 508 stacked along the axis AX, and a plurality of via wiring layers 601 to 607 each disposed between coil wiring layers adjacent in the direction of the axis AX and configured to connect the coil wiring layers adjacent in the direction of the axis AX. The plurality of coil wiring layers 501 to 508 are each disposed on a corresponding one of the insulating layers 11, and the plurality of via wiring layers 601 to 607 are each disposed in a corresponding one of the insulating layers 11.

The plurality of coil wiring layers 501 to 508 are each wound along a plane to form a helix while being electrically connected in series. The plurality of coil wiring layers 501 to 508 are each formed by being wound along the XZ plane (principal surface of the insulating layer 11) orthogonal to the direction of the axis AX (Y direction). Each of the coil wiring layers 501 to 508 has a constant width along the direction in which it extends. Although the number of turns of each of the coil wiring layers 501 to 508 is less than one, it may be greater than or equal to one.

The plurality of via wiring layers 601 to 607 penetrate the insulating layers 11 in the thickness direction (Y direction). The coil wiring layers adjacent in the stacking direction are electrically connected in series, with the via wiring layer therebetween. The plurality of coil wiring layers 501 to 508 are thus electrically connected in series, with the plurality of via wiring layers 601 to 607 therebetween, to allow the coil 20 to form a helix.

Specifically, the first coil wiring layer 501, the second coil wiring layer 502, the third coil wiring layer 503, the fourth coil wiring layer 504, the fifth coil wiring layer 505, the sixth coil wiring layer 506, the seventh coil wiring layer 507, and the eighth coil wiring layer 508 are stacked in sequence along the Y direction. An end portion of the first coil wiring layer 501 is connected to the first outer electrode conductor layer 33 of the first outer electrode 30. An end portion of the eighth coil wiring layer 508 is connected to the second outer electrode conductor layer 43 of the second outer electrode 40.

The first via wiring layer 601, the second via wiring layer 602, the third via wiring layer 603, the fourth via wiring layer 604, the fifth via wiring layer 605, the sixth via wiring layer 606, and the seventh via wiring layer 607 are stacked in sequence along the Y direction. The first via wiring layer 601 and the sixth via wiring layer 606 coincide, as viewed in the direction of the axis AX. The second via wiring layer 602 and the seventh via wiring layer 607 coincide, as viewed in the direction of the axis AX.

The first via wiring layer 601 is disposed between the first coil wiring layer 501 and the second coil wiring layer 502, and connects an end portion of the first coil wiring layer 501 to an end portion of the second coil wiring layer 502. The second via wiring layer 602 is disposed between the second coil wiring layer 502 and the third coil wiring layer 503, and connects the other end portion of the second coil wiring layer 502 to an end portion of the third coil wiring layer 503. The third via wiring layer 603 is disposed between the third coil wiring layer 503 and the fourth coil wiring layer 504, and connects the other end portion of the third coil wiring layer 503 to an end portion of the fourth coil wiring layer 504. The fourth via wiring layer 604 is disposed between the fourth coil wiring layer 504 and the fifth coil wiring layer 505, and connects the other end portion of the fourth coil wiring layer 504 to an end portion of the fifth coil wiring layer 505.

The fifth via wiring layer 605 is disposed between the fifth coil wiring layer 505 and the sixth coil wiring layer 506, and connects the other end portion of the fifth coil wiring layer 505 to an end portion of the sixth coil wiring layer 506. The sixth via wiring layer 606 is disposed between the sixth coil wiring layer 506 and the seventh coil wiring layer 507, and connects the other end portion of the sixth coil wiring layer 506 to an end portion of the seventh coil wiring layer 507. The seventh via wiring layer 607 is disposed between the seventh coil wiring layer 507 and the eighth coil wiring layer 508, and connects the other end portion of the seventh coil wiring layer 507 to an end portion of the eighth coil wiring layer 508.

As viewed in the direction of the axis AX, the plurality of via wiring layers 601 to 607 include at least one longitudinal via wiring layer having a longitudinal shape and extending along the helical direction of the coil 20. In the present embodiment, all the via wiring layers 601 to 607 are longitudinal via wiring layers. The via wiring layers 601 to 607 each have a constant width along the direction in which they extend. Some via wiring layers may have different widths along the direction in which they extend.

The length of the longitudinal via wiring layer is, for example, greater than or equal to 18 μm. The length of the longitudinal via wiring layer is greater than the width of the longitudinal via wiring layer, and the ratio of the length to the width of the longitudinal via wiring layer (length/width) is, for example, greater than or equal to 1.3. The length of the longitudinal via wiring layer is the length of the center line along the direction in which the longitudinal via wiring layer extends, as viewed in the direction of the axis AX. The width of the longitudinal via wiring layer is the length in the direction orthogonal to the center line along the direction in which the longitudinal via wiring layer extends, as viewed in the direction of the axis AX. In FIG. 3A to FIG. 3C, the center line is indicated by a dot-and-dash line. The length and the width of the longitudinal via wiring layer are measured, for example, with a laser microscope after the inductor component 1 is ground along the XZ plane.

It is simply required that at least one of the via wiring layers 601 to 607 be a longitudinal via wiring layer. The other via wiring layers may be circular (or rectangular) in shape, as viewed in the direction of the axis AX. In this case, an end portion of the coil wiring layer connected to the circular via wiring layer forms a circular pad portion, as viewed in the direction of the axis, and the diameter of the circular pad portion is greater than the line width of an intermediate portion of the coil wiring layer.

In the configuration described above, the plurality of via wiring layers 601 to 607 include at least one longitudinal via wiring layer. This can increase the area of contact between the coil wiring layer and the longitudinal via wiring layer and reduce direct-current resistance of the coil 20. During manufacture of the inductor component 1, lamination displacement may occur between the coil wiring layer and the longitudinal via wiring layer. However, since the area of the surface of the longitudinal via wiring layer facing the coil wiring layer is large, the probability of contact between the coil wiring layer and the longitudinal via wiring layer increases, and this can reduce the risk of contact failure between the coil wiring layer and the longitudinal via wiring layer. In the present embodiment, where all the via wiring layers 601 to 607 are longitudinal via wiring layers, the direct-current resistance of the coil 20 can be further reduced, and the risk of contact failure in the coil 20 can be further reduced.

At least one longitudinal via wiring layer includes a first longitudinal via wiring layer having a radius of curvature of greater than or equal to 15 μm, as viewed in the axial direction. In the present embodiment, all the longitudinal via wiring layers are first longitudinal via wiring layers. That is, all the via wiring layers 601 to 607 are first longitudinal via wiring layers. It is simply required that at least one of the via wiring layers 601 to 607 be a longitudinal via wiring layer, and that at least one longitudinal via wiring layer be a first longitudinal via wiring layer.

The radius of curvature of each of the first longitudinal via wiring layers (or the first to seventh via wiring layers 601 to 607 in the present embodiment) is the radius of curvature at the center line along the direction in which the first longitudinal via wiring layer extends, as viewed in the direction of the axis AX. When the first longitudinal via wiring layer has a plurality of radii of curvature, it is simply required that the smallest radius of curvature be greater than or equal to 15 μm.

Specifically, the first via wiring layer 601 has a first curved portion 601a, a second curved portion 601b, and a third curved portion 601c. The smallest of the radii of curvature of the first curved portion 601a, the second curved portion 601b, and the third curved portion 601c is greater than or equal to 15 μm.

Like the first via wiring layer 601, each of the second via wiring layer 602, the third via wiring layer 603, the fifth via wiring layer 605, the sixth via wiring layer 606, and the seventh via wiring layer 607 has at least one curved portion, and the smallest radius of curvature of the at least one curved portion is greater than or equal to 15 μm. Specifically, the second via wiring layer 602, the sixth via wiring layer 606, and the seventh via wiring layer 607 each have three curved portions, and the third via wiring layer 603 and the fifth via wiring layer 605 each have one curved portion.

The fourth via wiring layer 604 is linear, as viewed in the direction of the axis AX. That is, the fourth via wiring layer 604 has no curved portion. The radius of curvature of the fourth via wiring layer 604 is infinite and is greater than or equal to 15 μm. The fourth via wiring layer 604 is distant from the corners of the coil 20, as viewed in the direction of the axis AX. The other first longitudinal via wiring layers (or the first, second, third, fifth, sixth, and seventh via wiring layers 601, 602, 603, 605, 606, and 607 in the present embodiment) may be linear, as viewed in the direction of the axis AX.

The radius of curvature of each via wiring layer is measured, for example, with a laser microscope after the inductor component 1 is ground along the XZ plane.

In the configuration described above, at least one longitudinal via wiring layer includes a first longitudinal via wiring layer having a radius of curvature of greater than or equal to 15 μm, as viewed in the direction of the axis AX. The first longitudinal via wiring layer thus has a large radius of curvature. Therefore, even if the difference between the coefficient of linear expansion of the first longitudinal via wiring layer and the coefficient of linear expansion of the base body 10 causes stress, the stress is unlikely to concentrate on the first longitudinal via wiring layer. In particular, even if miniaturization of the inductor component 1 increases the ratio of the volume of the first longitudinal via wiring layer to the volume of the base body 10, the stress on the first longitudinal via wiring layer can be relieved. This can reduce the occurrence of cracks in the first longitudinal via wiring layer and improve the yield of the inductor component 1.

On the other hand, if the radius of curvature of a curved portion of the via wiring layer is less than 15 μm, the stress is more likely to concentrate on the curved portion. In particular, when miniaturization of the inductor component increases the ratio of the volume of the via wiring layer to the volume of the base body, the stress excessively concentrates on the via wiring layer. This may cause the occurrence of cracks in the curved portion of the via wiring layer, lower the electrical connectivity, and lead to a poor result in the characteristics selection process of the inductor component. Accordingly, the yield of the inductor component may be degraded.

In the configuration described above, where all the via wiring layers 601 to 607 are first longitudinal via wiring layers, stress is unlikely to concentrate on any of the via wiring layers 601 to 607.

In the configuration described above, at least one first longitudinal via wiring layer (fourth via wiring layer 604) is linear, as viewed in the direction of the axis AX. That is, at least one first longitudinal via wiring layer (fourth via wiring layer 604) has no curved portion. This makes it further unlikely that stress will concentrate on the at least one first longitudinal via wiring layer (fourth via wiring layer 604).

In the configuration described above, stress tends to be applied to the corners of the coil 20, as viewed in the direction of the axis AX. However, since the linear first longitudinal via wiring layer (fourth via wiring layer 604) is not disposed at the corners of the coil 20, stress is further unlikely to concentrate on the linear first longitudinal via wiring layer (fourth via wiring layer 604).

In the configuration described above, the first outer electrode 30 is embedded in the base body 10 to be exposed at the first end surface 15 and the bottom surface 17, and the second outer electrode 40 is embedded in the base body 10 to be exposed at the second end surface 16 and the bottom surface 17. Therefore, due to the difference between the thermal expansion coefficient of the first outer electrode 30 and the second outer electrode 40 and the thermal expansion coefficient of the base body 10, nonuniform stress biased particularly toward the bottom surface 17 tends to be applied to the base body 10 and the via wiring layers. Additionally, since the plurality of coil wiring layers 501 to 508 are each formed by being wound along the XZ plane (principal surface of the insulating layer 11) orthogonal to the direction of the axis AX (Y direction), stress tends to concentrate on parts of the via wiring layers close to the bottom surface 17. Even in this case, since at least one longitudinal via wiring layer includes a first longitudinal via wiring layer having a radius of curvature of greater than or equal to 15 μm, as viewed in the direction of the axis AX, stress is unlikely to concentrate on the first longitudinal via wiring layer. This can reduce the occurrence of cracks in the first longitudinal via wiring layer and improve the yield of the inductor component 1.

Preferably, at least one first longitudinal via wiring layer is linear and parallel to either the top surface 18 or the first end surface 15, as viewed in the direction of the axis AX. Specifically, the fourth via wiring layer 604 is parallel to the top surface 18, as viewed in the direction of the axis AX. This can increase the inside diameter of the coil 20 and improve the inductance value. The via wiring layers may include a linear first longitudinal via wiring layer parallel to the first end surface 15, as viewed in the direction of the axis AX.

Preferably, the plurality of insulating layers 11 of the base body 10 include a first insulating layer in the same layer as a first longitudinal via wiring layer. The ratio of the volume of the first longitudinal via wiring layer to the volume of the first insulating layer is greater than or equal to 9.2%. When there are a plurality of first longitudinal via wiring layers, it is simply required that the volume ratio of at least one of a plurality of pairs of a first longitudinal via wiring layer and a first insulating layer be greater than or equal to 9.2%.

Specifically, in the first via wiring layer 601 (first longitudinal via wiring layer) and the insulating layer 11 (first insulating layer) in the same layer as the first via wiring layer 601, the ratio of the volume of the first via wiring layer 601 to the volume of the insulating layer 11 is greater than or equal to 9.2%. As in the first via wiring layer 601, the ratio of the volume of each of the second to seventh via wiring layers 602 to 607 to the volume of the insulating layer in the same layer as the corresponding via wiring layer is greater than or equal to 9.2%.

A method for measuring the ratio of the volume of the first longitudinal via wiring layer to the volume of the first insulating layer will now be described. First, the inductor component 1 is ground along the XZ plane, and the length (L) of the first longitudinal via wiring layer and the cross-sectional area (S1) of the first insulating layer in the same layer as the first longitudinal via wiring layer are measured with a laser microscope. The length of the first longitudinal via wiring layer is the length of the center line along the direction in which the first longitudinal via wiring layer extends, as viewed in the axial direction. Next, the inductor component 1 is ground in the direction orthogonal to the XZ plane and orthogonal to the center line of the first longitudinal via wiring layer to expose the cross-section of the first longitudinal via wiring layer, and the area(S) of the cross-section of the first longitudinal via wiring layer and the maximum thickness (T) of the first longitudinal via wiring layer in the Y direction are measured with the laser microscope. Then, the volume of the first longitudinal via wiring layer is calculated by multiplying the length (L) and the area(S). Also, the volume of the first insulating layer is calculated by multiplying the cross-sectional area (S1) of the first insulating layer with the thickness (T). Then, the ratio of the volume of the first longitudinal via wiring layer to the volume of the first insulating layer is calculated from the volume of the first longitudinal via wiring layer and the volume of the first insulating layer.

In the configuration described above, the ratio of the volume of the first longitudinal via wiring layer to the volume of the first insulating layer is greater than or equal to 9.2%, and the volume ratio of the first longitudinal via wiring layer to the base body is thus large. Accordingly, even when the component is miniaturized, the direct-current resistance can be reduced. Even in this state, the radius of curvature of the first longitudinal via wiring layer is greater than or equal to 15 μm, and the stress on the first longitudinal via wiring layer can be relieved.

Preferably, the length dimension of the inductor component 1 (or dimension in the X direction) is less than or equal to 265 μm, the height dimension of the inductor component 1 (or dimension in the Z direction) is less than or equal to 215 μm, and the width dimension of the inductor component 1 (or dimension in the Y direction) is less than or equal to 140 μm. The configuration described above makes the inductor component 1 small. Even in this state, the radius of curvature of the first longitudinal via wiring layer is greater than or equal to 15 μm, and the stress on the first longitudinal via wiring layer can be relieved. A method for manufacturing the inductor component 1 will now be described.

As illustrated in FIG. 3A, FIG. 3B, and FIG. 3C, the inductor component 1 is manufactured by alternately stacking the first to eighth coil wiring layers 501 to 508 and the first to seventh via wiring layers 601 to 607 together with the insulating layers 11 in the direction from top to bottom in the drawings. The coil wiring layers 501 to 508 are produced, for example, by screen printing on the insulating layers 11. The via wiring layers 601 to 607 are produced, for example, by screen printing in openings formed, for example, by a photolithographic or laser technique in the insulating layers 11.

### Second Embodiment

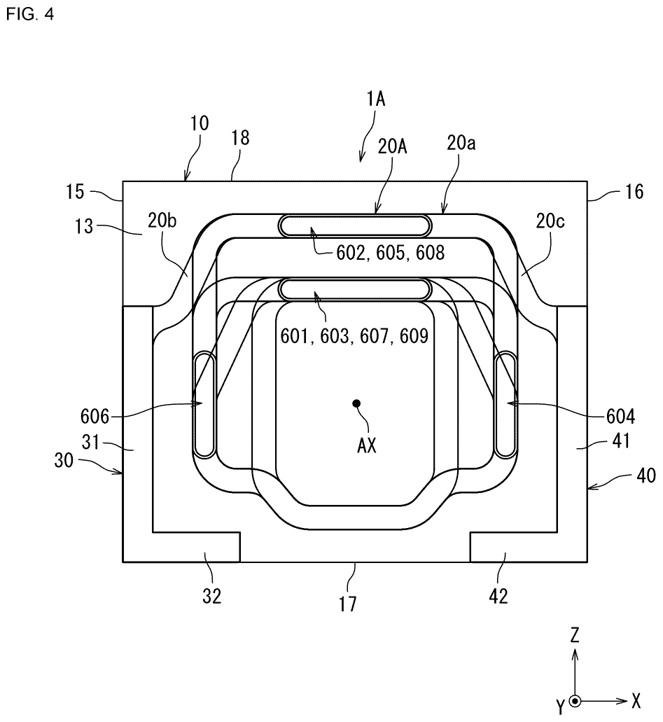

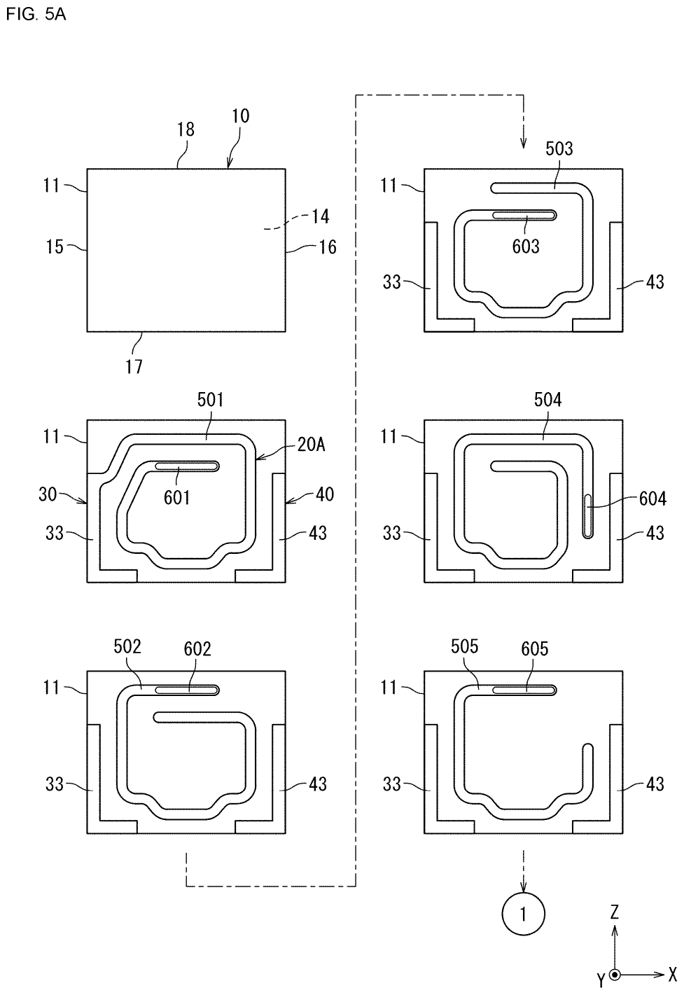

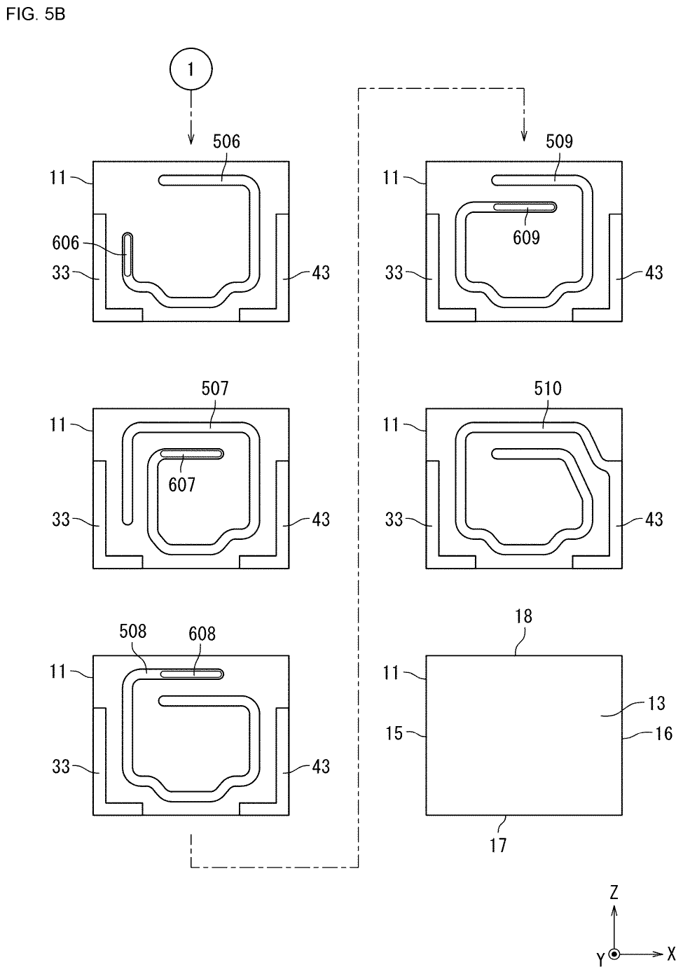

FIG. 4 is a transparent front view of a second embodiment of the inductor component, as viewed from the first side surface of the inductor component. FIG. 5A and FIG. 5B are exploded plan views of the inductor component. The second embodiment differs from the first embodiment in coil configuration. This difference will now be described. The other configurations are the same as those of the first embodiment and their description will be omitted by assigning the same reference numerals as those in the first embodiment.

As illustrated in FIG. 4, FIG. 5A, and FIG. 5B, in an inductor component 1A of the second embodiment, a coil 20A includes a plurality of coil wiring layers 501 to 510 stacked along the axis AX, and a plurality of via wiring layers 601 to 609 each disposed between coil wiring layers adjacent in the direction of the axis AX and configured to connect the coil wiring layers adjacent in the direction of the axis AX. The plurality of coil wiring layers 501 to 510 are each disposed on a corresponding one of the insulating layers 11, and the plurality of via wiring layers 601 to 609 are each disposed in a corresponding one of the insulating layers 11. Note that the insulating layers 11 in the same layers as the via wiring layers 601 to 609 are not illustrated in FIG. 5A and FIG. 5B.

The plurality of coil wiring layers 501 to 510 are each wound along a plane to form a helix while being electrically connected in series. The plurality of coil wiring layers 501 to 510 are each formed by being wound along the XZ plane (principal surface of the insulating layer 11) orthogonal to the direction of the axis AX (Y direction). All the coil wiring layers 501 to 510 have a constant width along the direction in which they extend.

The plurality of via wiring layers 601 to 609 penetrate the insulating layers 11 in the thickness direction (Y direction). As viewed in the direction of the axis AX, the plurality of via wiring layers 601 to 609 extend along the helical direction of the coil 20A. The coil wiring layers adjacent in the stacking direction are electrically connected in series, with the via wiring layer therebetween.

Specifically, the first coil wiring layer 501, the second coil wiring layer 502, the third coil wiring layer 503, the fourth coil wiring layer 504, the fifth coil wiring layer 505, the sixth coil wiring layer 506, the seventh coil wiring layer 507, the eighth coil wiring layer 508, the ninth coil wiring layer 509, and the tenth coil wiring layer 510 are stacked in sequence along the Y direction. An end portion of the first coil wiring layer 501 is connected to the first outer electrode conductor layer 33 of the first outer electrode 30. An end portion of the tenth coil wiring layer 510 is connected to the second outer electrode conductor layer 43 of the second outer electrode 40.

The number of turns of each of the fifth coil wiring layer 505 and the sixth coil wiring layer 506 is less than one. The number of turns of each of the first to fourth coil wiring layers 501 to 504 and the seventh to tenth coil wiring layers 507 to 510 is greater than or equal to one. Since this can increase the number of turns of the coil 20A while reducing the size of the coil 20A in the direction of the axis AX, both miniaturization and an improved inductance value can be achieved. It is simply required that the number of turns of at least one of all the coil wiring layers be greater than or equal to one, so that both miniaturization and an improved inductance value can be achieved. The number of turns of every coil wiring layer may be less than one.

The first via wiring layer 601, the second via wiring layer 602, the third via wiring layer 603, the fourth via wiring layer 604, the fifth via wiring layer 605, the sixth via wiring layer 606, the seventh via wiring layer 607, the eighth via wiring layer 608, and the ninth via wiring layer 609 are stacked in sequence along the Y direction. The first via wiring layer 601, the third via wiring layer 603, the seventh via wiring layer 607, and the ninth via wiring layer 609 coincide, as viewed in the direction of the axis AX. The second via wiring layer 602, the fifth via wiring layer 605, and the eighth via wiring layer 608 coincide, as viewed in the direction of the axis AX. All the via wiring layers 601 to 609 have a constant width along the direction in which they extend. Some via wiring layers may have different widths along the direction in which they extend.

The first via wiring layer 601 is disposed between the first coil wiring layer 501 and the second coil wiring layer 502, and connects an end portion of the first coil wiring layer 501 to an end portion of the second coil wiring layer 502. The second via wiring layer 602 is disposed between the second coil wiring layer 502 and the third coil wiring layer 503, and connects the other end portion of the second coil wiring layer 502 to an end portion of the third coil wiring layer 503. The third via wiring layer 603 is disposed between the third coil wiring layer 503 and the fourth coil wiring layer 504, and connects the other end portion of the third coil wiring layer 503 to an end portion of the fourth coil wiring layer 504. The fourth via wiring layer 604 is disposed between the fourth coil wiring layer 504 and the fifth coil wiring layer 505, and connects the other end portion of the fourth coil wiring layer 504 to an end portion of the fifth coil wiring layer 505. The fifth via wiring layer 605 is disposed between the fifth coil wiring layer 505 and the sixth coil wiring layer 506, and connects the other end portion of the fifth coil wiring layer 505 to an end portion of the sixth coil wiring layer 506.

The sixth via wiring layer 606 is disposed between the sixth coil wiring layer 506 and the seventh coil wiring layer 507, and connects the other end portion of the sixth coil wiring layer 506 to an end portion of the seventh coil wiring layer 507. The seventh via wiring layer 607 is disposed between the seventh coil wiring layer 507 and the eighth coil wiring layer 508, and connects the other end portion of the seventh coil wiring layer 507 to an end portion of the eighth coil wiring layer 508. The eighth via wiring layer 608 is disposed between the eighth coil wiring layer 508 and the ninth coil wiring layer 509, and connects the other end portion of the eighth coil wiring layer 508 to an end portion of the ninth coil wiring layer 509. The ninth via wiring layer 609 is disposed between the ninth coil wiring layer 509 and the tenth coil wiring layer 510, and connects the other end portion of the ninth coil wiring layer 509 to an end portion of the tenth coil wiring layer 510.

All the via wiring layers 601 to 609 are first longitudinal via wiring layers, and all the first longitudinal via wiring layers are linear, as viewed in the direction of the axis AX. That is, all the via wiring layers 601 to 609 are linear, as viewed in the direction of the axis AX. In the configuration described above, none of the first longitudinal via wiring layers (via wiring layers 601 to 609) has a curved portion. This makes it further unlikely that stress will concentrate on the first longitudinal via wiring layers (via wiring layers 601 to 609).

All the linear first longitudinal via wiring layers (via wiring layers 601 to 609) are distant from the corners of the coil 20A, as viewed in the direction of the axis AX. In the configuration described above, stress tends to be applied to the corners of the coil 20A, as viewed in the direction of the axis AX. However, since none of the first longitudinal via wiring layers is disposed at the corners of the coil 20A, stress is further unlikely to concentrate on any of the first longitudinal via wiring layers.

Preferably, all the first longitudinal via wiring layers are linear, as viewed in the direction of the axis AX, and are parallel to either the top surface 18 or the first end surface 15. Specifically, the first, second, third, fifth, seventh, eighth, and ninth via wiring layers 601, 602, 603, 605, 607, 608, and 609 are parallel to the top surface 18, as viewed in the direction of the axis AX. The fourth and sixth via wiring layers 604 and 606 are parallel to the first end surface 15, as viewed in the direction of the axis AX. This can increase the inside diameter of the coil 20 and improve the inductance value.

The present disclosure is not limited to the embodiments described above, and design changes can be made without departing from the scope of the present disclosure. For example, features of the first and second embodiments may be variously combined. The number of coil wiring layers may be either increased or decreased, and the number of via wiring layers may be either increased or decreased. For example, the number of via wiring layers is simply required to be greater than or equal to one.

The present disclosure includes the following aspects.
<1> An inductor component includes a base body, a coil disposed inside the base body and helically wound along an axis, and a first outer electrode and a second outer electrode disposed in the base body and electrically connected to the coil. The base body includes a first end surface and a second end surface opposite each other, a first side surface and a second side surface opposite each other, a bottom surface connected between the first end surface and the second end surface and between the first side surface and the second side surface, and a top surface opposite the bottom surface. The first outer electrode and the second outer electrode are disposed at least on the bottom surface. The axis is parallel to the bottom surface and intersects with the first side surface and the second side surface. The coil includes a plurality of coil wiring layers stacked along the axis, and a via wiring layer configured to connect adjacent ones of the coil wiring layers in an axial direction, which is a direction of the axis. The via wiring layer includes at least one longitudinal via wiring layer having a longitudinal shape and extending along a helical direction of the coil, as viewed in the axial direction, and the at least one longitudinal via wiring layer includes a first longitudinal via wiring layer having a radius of curvature of greater than or equal to 15 μm, as viewed in the axial direction.
<2> In the inductor component according to <1>, the base body includes a plurality of insulating layers stacked along the axis. The plurality of insulating layers include a first insulating layer in the same layer as the first longitudinal via wiring layer. A ratio of a volume of the first longitudinal via wiring layer to a volume of the first insulating layer is greater than or equal to 9.2%.
<3> In the inductor component according to <1> or <2>, a length dimension of the inductor component is less than or equal to 265 μm, a height dimension of the inductor component is less than or equal to 215 μm, and a width dimension of the inductor component is less than or equal to 140 μm.
<4> In the inductor component according to any one of <1> to <3>, every via wiring layer is the first longitudinal via wiring layer.
<5> In the inductor component according to any one of <1> to <4>, at least one first longitudinal via wiring layer is linear, as viewed in the axial direction.
<6> In the inductor component according to any one of <1> to <5>, every first longitudinal via wiring layer is linear, as viewed in the axial direction.
<7> In the inductor component according to any one of <1> to <6>, every first longitudinal via wiring layer is linear, as viewed in the axial direction, and the every first longitudinal via wiring layer is distant from corners of the coil, as viewed in the axial direction.
<8> In the inductor component according to <5>, the at least one first longitudinal via wiring layer is parallel to either the top surface or the first end surface, as viewed in the axial direction.
<9> In the inductor component according to <6>, the every first longitudinal via wiring layer is parallel to either the top surface or the first end surface, as viewed in the axial direction.

What is claimed is:

1. An inductor component comprising:
a base body including a first end surface and a second end surface opposite each other, a first side surface and a second side surface opposite each other, a bottom surface connected between the first end surface and the second end surface and between the first side surface and the second side surface, and a top surface opposite the bottom surface;
a coil inside the base body and helically wound along an axis, and the axis being parallel to the bottom surface and intersecting with the first side surface and the second side surface; and
a first outer electrode and a second outer electrode in the base body and electrically connected to the coil, the first outer electrode and the second outer electrode being at least on the bottom surface,
wherein
the coil includes a plurality of coil wiring layers stacked along the axis, and a via wiring layer configured to connect adjacent ones of the coil wiring layers in an axial direction, the axial direction being a direction of the axis,
the via wiring layer includes at least one longitudinal via wiring layer having a longitudinal shape and extending along a helical direction of the coil, as viewed in the axial direction, and
the at least one longitudinal via wiring layer includes a first longitudinal via wiring layer having a radius of curvature of greater than or equal to 15 μm, as viewed in the axial direction.

2. The inductor component according to claim 1, wherein
the base body includes a plurality of insulating layers stacked along the axis;
the plurality of insulating layers include a first insulating layer in a same layer as the first longitudinal via wiring layer; and
a ratio of a volume of the first longitudinal via wiring layer to a volume of the first insulating layer is greater than or equal to 9.2%.

3. The inductor component according to claim 1, wherein
a length dimension of the inductor component is less than or equal to 265 μm;
a height dimension of the inductor component is less than or equal to 215 μm; and
a width dimension of the inductor component is less than or equal to 140 μm.

4. The inductor component according to claim 1, wherein
every via wiring layer is the first longitudinal via wiring layer.

5. The inductor component according to claim 1, wherein
at least one first longitudinal via wiring layer is linear, as viewed in the axial direction.

6. The inductor component according to claim 1, wherein
every first longitudinal via wiring layer is linear, as viewed in the axial direction.

7. The inductor component according to claim 1, wherein
every first longitudinal via wiring layer is linear, as viewed in the axial direction; and
the every first longitudinal via wiring layer is distant from corners of the coil, as viewed in the axial direction.

8. The inductor component according to claim 5, wherein
the at least one first longitudinal via wiring layer is parallel to either the top surface or the first end surface, as viewed in the axial direction.

9. The inductor component according to claim 6, wherein
the every first longitudinal via wiring layer is parallel to either the top surface or the first end surface, as viewed in the axial direction.

10. The inductor component according to claim 2, wherein
a length dimension of the inductor component is less than or equal to 265 μm;
a height dimension of the inductor component is less than or equal to 215 μm; and
a width dimension of the inductor component is less than or equal to 140 μm.

11. The inductor component according to claim 2, wherein
every via wiring layer is the first longitudinal via wiring layer.

12. The inductor component according to claim 2, wherein
at least one first longitudinal via wiring layer is linear, as viewed in the axial direction.

13. The inductor component according to claim 2, wherein
every first longitudinal via wiring layer is linear, as viewed in the axial direction.

14. The inductor component according to claim 2, wherein
every first longitudinal via wiring layer is linear, as viewed in the axial direction; and
the every first longitudinal via wiring layer is distant from corners of the coil, as viewed in the axial direction.

15. The inductor component according to claim 12, wherein
the at least one first longitudinal via wiring layer is parallel to either the top surface or the first end surface, as viewed in the axial direction.

16. The inductor component according to claim 13, wherein
the every first longitudinal via wiring layer is parallel to either the top surface or the first end surface, as viewed in the axial direction.
